(19) United States
(12) Patent Application Publication
(10) Pub. No.: US 2003/0058500 A1
(43) Pub. Date: Mar. 27, 2003

(54) Optical signal processing system

(75) Inventor: Mitsuru Sugawara, Kawasaki (JP)

Correspondence Address: ARMSTRONG,WESTERMAN & HATTORI, LLP, 1725 K STREET, NW, SUITE 1000, WASHINGTON, DC, 20006, US

(73) Assignee: Fujitsu Limited, Kawasaki (JP)

(21) Appl. No.: 10/109,884

(22) Filed: Apr. 1, 2002

(30) Foreign Application Priority Data
Sep. 27, 2001 (JP) 2001-297192

(51) Int. Cl. H04J 14/08; H04B 10/00

(52) U.S. Cl. 359/135; 359/154

(57) ABSTRACT

There are provided a first optical transmitting device for transmitting a first light having a first wavelength in a continuous light state and a second light having signal optical pulses and a second wavelength, a first optical amplifier for receiving the first light and the second light from the first optical transmitting device, a pulse light source for outputting a controlling optical pulse train having a third wavelength, a second optical transmitting device for transmitting the first light, on which a waveform is superposed by the first optical amplifier, and the controlling optical pulse train being output from the pulse light source, and a second optical amplifier for receiving the first light and the controlling optical pulse train from the second optical transmitting device and then outputting an output optical signal having the third wavelength, on which the signal pulse is superposed.

### CROSS-REFERENCE TO RELATED APPLICATIONS

This application is based upon and claims priority of Japanese Patent Application No. 2001-297192, filed in Sep. 27, 2001, the contents being incorporated herein by reference.

### BACKGROUND OF THE INVENTION

1. Field of the Invention

The present invention relates to an optical signal processing system and, more particularly, an optical signal processing system that is available for the long-distance large-traffic optical communication, etc.

2. Description of the Prior Art

The wavelength division multiplexing (WDM) optical communication system has been developed as the optical communication system in the large-traffic optical network. Also, the optical time division multiplexing (OTDM) optical communication system aiming at the large traffic optical communication or the time wavelength division multiplexing (TWDM) optical communication system in which the WDM optical communication system and the OTDM optical communication system are combined together has been proposed. Researches and developments of these systems are advanced.

The WDM optical communication system increases the signal density by wavelength-multiplexing the signal light. Also, the time dividing system such as OTDM or TWDM intends to increase the signal density of the pulsed light that has a very narrow time width of the same wavelength.

The WDM has a configuration shown in FIG. 1, for example, and the OTDM has a configuration shown in FIG. 2, for example.

In FIG. 1 and FIG. 2, a multiplexer (MUX) 101 that optically multiplexes the light source signals is connected to the demultiplexer (DEMUX) 105 via the 2R/3R element 102, the optical add-drop multiplexer (OADM) 103 and the optical fiber 104.

The 2R/3R element 102 is a regenerator of the optical signal, and has a 3R regenerating element that has three functions of regenerating, reshaping, and retiming functions or a 2R regenerating element that has two functions of regenerating and reshaping functions. The optical add-drop multiplexer 103 is an optical switching system that is capable of adding and dropping arbitrarily the optical signal every wavelength without the conversion into the electric signal.

In the WDM optical communication system shown in FIG. 1, multi-wavelength optical signals λ₁, λ₂, . . . , λₙ are multiplexed multiplicately by the multiplexer 101 without the time division. These optical signals λ₁, λ₂, . . . , λₙ are demultiplexed by the demultiplexer 105 every wavelength.

In the OTDM optical communication system shown in FIG. 2, a plurality of optical signals T₁, T₂, T₃, T₄ that are subjected to the time division are multiplexed by the multiplexer 101 and then demultiplexed by the demultiplexer 105.

The optical signal processing system, that executes the signal processing such as relaying, multiplexing, demultiplexing, routing, etc. of the optical signals in the middle of the optical transmission, as well as the multi-wavelength high-speed light source, is indispensable to increase the traffic by using the above communication systems.

In the optical signal processing according to the early optical communication system, the method of converting the optical signal into the electric signal and then processing such electric signal is employed.

For example, in the 3R regenerative relay system, first the optical signal is detected and converted into the electric signal, and then the reshaping is applied in the electric domain. Then, the clock (sine wave of the frequency of the bit rate) is extracted from the reshaped signal, and then the retiming for deciding the timing at which on-off decision is made according to the clock is carried out. Then, the regeneration in which such on-off is discriminated and the light source is modulated again based on this discriminating signal to send out the strong light is carried out. Three functions of these reshaping, retiming, and regenerating functions are called the 3R-function.

At present, the optical amplifying technology that can amplify the optical signal as it is by using the erbium (Er)-doped optical fiber, etc. makes progress, and thus the optical signal can be relayed not to convert the optical signal into the electric signal. This amplifier can compensate the loss but does not have the retiming and reshaping functions, unlike the above 3R regenerative repeater. As a result, the waveform distortion and the pulse jitter are accumulated in the analog system. In contrast to such defect, since the light-electricity conversion is not carried out, such amplifier has such a merit that high-speed modulated signals can be relayed without the restriction of the electronic circuits and such a merit that multi-wavelength (multi-channel) signals used in the WDM can be processed simultaneously.

This optical amplifying technology is sufficient if the multiplexing in time/wavelength domains is not so high in density, and thus this optical fiber amplifying technology is widely employed in the optical communication at the present stage.

However, in future the necessity of executing the regeneration of the optical pulse is rapidly enhanced with the progress of the multiplexing in the time domain particularly. Thus, the technology that is in conformity with this necessity is requested. For example, in order to proceed the multiplexing in the time domain, reduction in the pulse width, increase in the bit rate, reduction in the optical pulse energy, etc. are needed. In this case, the reduction in the pulse width causes collapse of the waveform of the optical pulse due to the group velocity dispersion, the increase in the bit rate causes the increase in the reading error due to the interference between pulses, and the reduction in the optical pulse energy causes the increase in the reading error due to the reduction of the S/N ratio generated by the ASE (Amplified Spontaneous Emission) noise from the optical fiver amplifier. For this reason, the repeater is required once again.

However, in the optical repeating operation by using the electricity in the prior art, there is the limitation in the aspect of the velocity. That is, since the response speed of the electric signal is limited by the drift velocity of the carrier of the electronic device and the CR time constant and also the speed limit in the optical signal process by the electricity is 10 to 40 Gb/s, it is impossible to deal with the high-speed signal in excess of this time- multiplexed bit rate. Also, it is apparent that it needs a great cost to execute the regeneration from the light to the electricity or from the electricity to the light.

With the above description, the all optical 3R-repeating technology that does not depend on the light-electricity conversion but executes the optical signal processing by the light as it is the technology indispensable for the larger capacity of the optical communication.

Also, if the multiplexing in the time domain makes progress, the optical demultiplexer (DEMUX) element for demultiplexing the optical signal into the signal having the bit rate, which can be dealt with the electronic devices, is also needed. As described above, the speed limit of the optical signal processing by the electricity is 10 to 40 Gb/s. Thus, in order to process the OTDM signal in which the optical signals having these bit rates are multiplexed, first the DEMUX device for demultiplexing respective signal components as the light as it is is essential.

Meanwhile, it is the element having a function for processing the multi-channel optical signals collectively that is requested with the progress of the wavelength multiplexing. It brings about the increase in size of the system and the increase in cost to prepare the repeater and the DEMUX device every channel one by one. Even if the high-speed switch that can deal with plural channels, e.g., 2 or 3 channels, simultaneously can be achieved, the reduction of the system and the lower cost can be brought about. In addition, in order to execute the routing of the optical signal on different channels on the network, the wavelength-converting element for converting some wavelength to other wavelength is also expected.

As described above, for the multiplexing in the time/wavelength domains of the future optical communication, the functions required for the optical signal processing system are summarized as follows.

That is, \mathring{1} to attain the high-speed response of more than 10 to 40 Gb/s, \mathring{2} to execute the processing of any bit pattern, \mathring{3} to execute basically the processing of the signal without the wavelength conversion, \mathring{4} to execute the wavelength conversion if necessary, \mathring{5} to process two signals or more having different wavelengths without the crosstalk, etc. However, the system having such functions has not been known.

Up to now, several optical signal processing systems having the optical repeating function and the DEMUX function have been reported, but they did not satisfy the performances required as above. As the prior art, the optical signal processing system having the optical repeating function and the DEMUX function has been reported in D. Wolfson et al., IEEE Photonic Tech. Lett. 12, 332(2000), “40 Gb/s All optical wavelength conversion, regeneration, and demultiplexing in an SOA-based all-active Mach-Zehnder Interferometer”, for example.

### SUMMARY OF THE INVENTION

It is an object of the present invention to provide an optical signal processing system suitable for the high-speed response.

The above subjects can be overcome by providing an optical signal processing system which comprises a first optical transmitting means for transmitting a first light having a first wavelength in a continuous light state and a second light having signal optical pulses and a second wavelength, a first optical amplifier for receiving the first light and the second light from the first optical transmitting means, a pulse light source for outputting a controlling optical pulse train having a third wavelength, a second optical transmitting means for transmitting the first light on which a waveform is superposed by the first optical amplifier and the controlling optical pulse train output from the pulse light source, and a second optical amplifier for receiving the first light and the controlling optical pulse train from the second optical transmitting means and outputting an output optical signal having the third wavelength, on which the signal pulse is superposed.

According to the present invention, the first light as the continuous light having the first wavelength and the second light having the waveform of the signal optical pulse and the second wavelength are input into the first optical amplifier, whereby the intensity profile of the first light can be modulated into the waveform, which is the inverted waveform of the signal optical pulse, and can be optically amplified. Also, the first light that is output from the first optical amplifier and the controlling optical pulse train that is output from the pulse light source are input into the second optical amplifier. Accordingly, the optical pulse of the controlling optical pulse train, which is synchronized with the low level intensity of the first light, can be optically amplified by the second optical amplifier, and also the intensity of the optical pulse, which is synchronized with the high level intensity of the first light, can be lowered and output as the signal light. The optical output has the substantially same wavelength as the controlling optical pulse train.

Therefore, the second light having the second wavelength and the optical signal whose waveform is collapsed can be wavelength-converted into the output optical signal of the third wavelength by the first and second optical amplifiers and can be reproduced. In this case, if the third wavelength and the second wavelength are set equal to each other, the waveform of the optical signal of the second light can be output from the second optical amplifier as the output optical signal having the second wavelength, and thus can be reshaped and amplified without the wavelength conversion and thus can be perfectly reproduced.

As a result, the perfect reproduction of the optical signals whose waveform is collapsed by the noise, the variation in the intensity, the jitter, etc. can be achieved. Also, the DEMUX and the wavelength conversion of the optical time-division multiplexing signal can be achieved by employing such configuration.

### BRIEF DESCRIPTION OF THE DRAWINGS

FIG. 1 is a circuit block diagram showing a configuration of WDM in the prior art;

FIG. 2 is a circuit block diagram showing a configuration of OTDM in the prior art;

FIG. 3 is a perspective view showing SOA employed in an embodiment of the present invention;

FIG. 4 is a sectional view showing a structure of an active layer of SOA employed in the embodiment of the present invention;

FIG. 5 is a view showing a conduction band energy of a quantum dot formed in the active layer shown in FIG. 4;

FIGS. 6A to 6D are gain spectra showing the operational principle of SOA employed in the embodiment of the present invention;

FIG. 7 is a view showing an optical input-optical output characteristic of SOA employed in the embodiment of the present invention;

FIG. 8 is a view showing a configuration of a regenerating/reshaping element employed in the embodiment of the present invention;

FIG. 9 is a view showing a configuration of a wavelength converting element employed in the embodiment of the present invention;

FIG. 10 is a view showing a configuration of a first optical signal processing system according to the embodiment of the present invention;

FIG. 11 is a view showing a configuration of a second optical signal processing system according to the embodiment of the present invention;

FIG. 12 is a view showing a configuration of a third optical signal processing system according to the embodiment of the present invention; and

FIG. 13 shows a gain curve that is spread according to a size distribution of quantum dots in SOA employed in the optical signal processing system according to the embodiment of the present invention and gain saturation obtained when optical signals are incident.

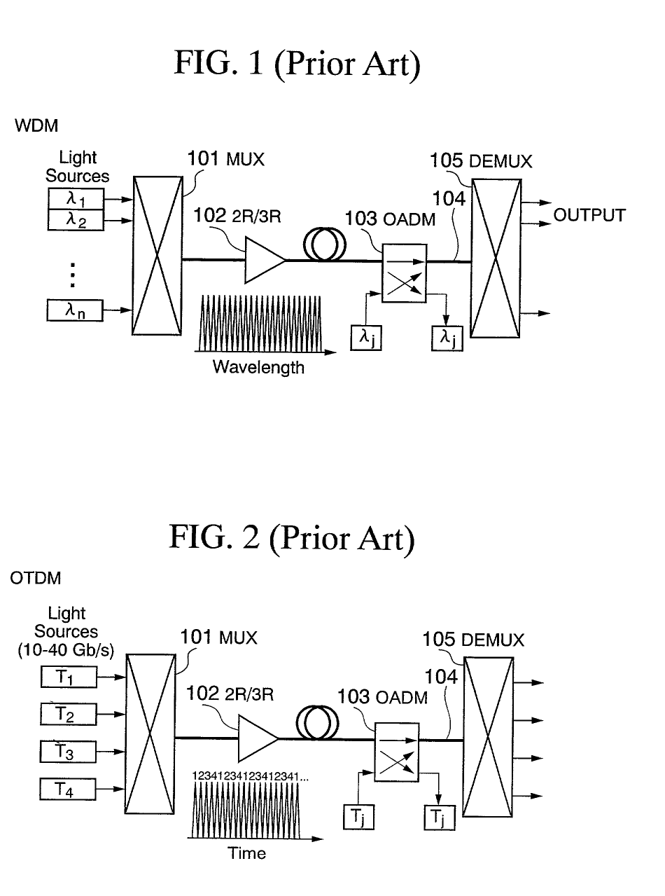

### DETAILED DESCRIPTION OF THE PREFERRED EMBODIMENTS

An embodiment of the present invention will be explained with reference to the accompanying drawings hereinafter.

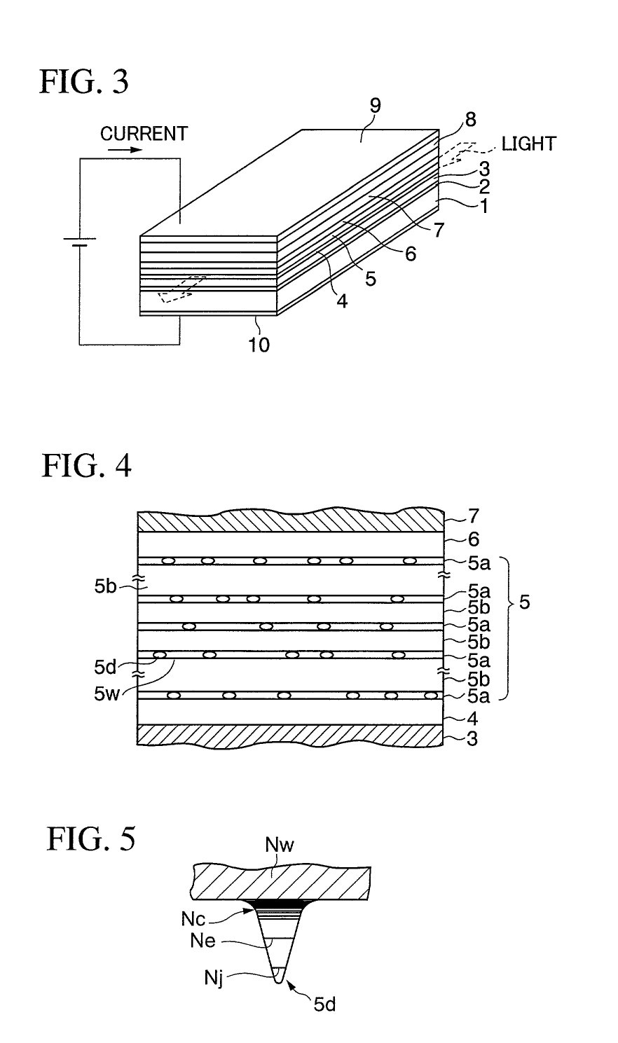

FIG. 3 shows a semiconductor optical amplifier (abbreviated as “SOA” hereinafter) employed in an embodiment of the present invention.

The SOA has a structure in which a buffer layer 2 formed of n-type GaAs of 1 μm thickness, an n-type cladding layer 3 formed of n-type Al_{0.4}Ga_{0.6}As of 0.5 μm thickness, a lower optical confinement layer 4 formed of GaAs of 0.1 μm thickness, an active layer 5, an upper optical confinement layer 6 formed of GaAs of 0.1 μm thickness, a p-type cladding layer 7 formed of p-type Al_{0.4}Ga_{0.6}As of 1.0 μm thickness, and a p-type contact layer 8 formed of GaAs of 0.2 μm thickness are formed in sequence on an n-type GaAs substrate 1 having a thickness of 300 μm. An n-type impurity concentration of the n-type GaAs substrate 1, the buffer layer 2, and the n-type cladding layer 3 is about 1×10¹⁸ cm⁻³ respectively, and a p-type impurity concentration of the p-type cladding layer 7 and the p-type contact layer 8 is about 1×10¹⁸ cm⁻³ respectively.

As shown in FIG. 4, for example, the active layer 5 has a semiconductor quantum dot structure that is constructed by laminating a quantum dot layer 5a and a GaAs layer 5b alternatively. For instance, the quantum dot layer 5a has ten layers and the GaAs layer 5b has nine layers. A thickness of the quantum dot layer 5a is 25 nm, and a thickness of the GaAs layer 5b is 25 nm. The quantum dot layer 5a consists of a number of quantum dots 5d formed of InAs irregularly as an underlying, and a wetting layer 5w formed of InGaAs to fill spaces between the quantum dots 5d. A size of the quantum dot 5d is about 20 nm. The quantum dot 5d confines the carrier three-dimensionally.

Respective layers from the buffer layer 2 to the contact layer 8 are grown by the crystal growth method such as the molecular beam epitaxy (MBE) method, for example.

A p-side electrode 9 made of AuZn alloy, for example, is formed on an upper surface of the p-type contact layer 8. Also, an n-side electrode 10 made of AuGe alloy, for example, is formed on a lower surface of the n-type GaAs substrate 1.

The quantum dot 5d is formed of a semiconductor that is smaller than the wavelength of the electron. The quantum dot 5d may have various shapes such as the shape close to the sphere, the flat lens shape, the rectangular prism shape, or the like. The distinctive feature of the quantum dot 5d is that the energy levels of the electron confined in the inside of the quantum dot 5d are perfectly quantized and become discrete. It is expected that, by forming such quantum dots 5d in the active layer 5, the interaction between the electron and the light can be enhanced and the high performance semiconductor laser can be realized. Thus, such quantum dots 5d are studied for many years.

As the method of fabricating the quantum dots 5d, the self-assembled method is widely employed. The self-assembled method is such a method that the quantum dots are obtained by growing the semiconductor material, which has the lattice constant different from the substrate, on the semiconductor substrate. Since the lattice constants are different, the strong strain energy is accumulated between the substrate and the semiconductor grown thereon if the ordinary two-dimensional growth is employed. In order to avoid this, the semiconductor is grown into not two-dimensional island but three-dimensional island. Because the size of the island is similar to the wavelength of the electron, the energy of the electron in the quantum dot 5d is quantized.

For this reason, the energy levels of the electron in the conduction band of the quantum dot 5d are distributed discretely, as shown in FIG. 5. The energy levels in FIG. 5 are distributed into the ground state Nⱼ, the primary excited state Ne, and the secondary excited state Nc or more. Since difference between the energy levels in the secondary excited state Nc or more is smaller than difference between the primary excited state Ne and the ground state Nⱼ or difference between the secondary excited state Nc and the ground state Nⱼ, the secondary excited state Nc or more can be regarded as the continuous state. In FIG. 5, N_{w} denotes the electron density that occupies the continuous state in the wetting layer 5w.

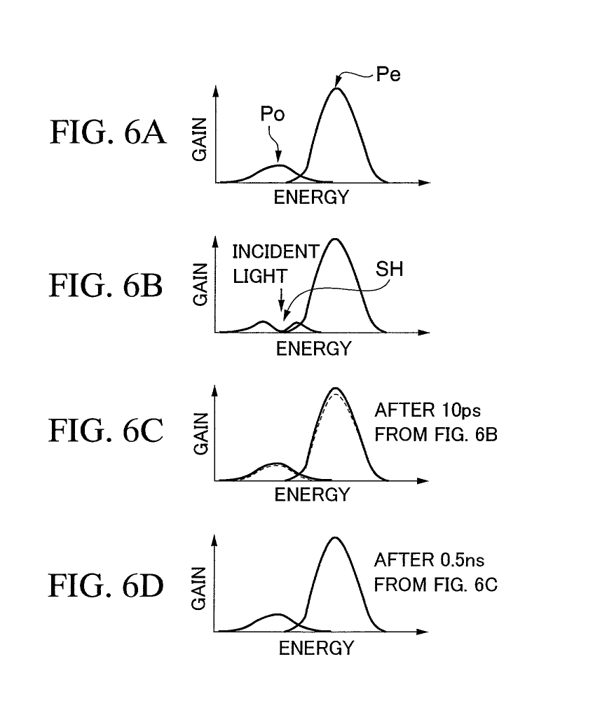

As shown in FIG. 6A, in the gain spectrum of SOA having the quantum dots 5d, a peak Po corresponding to the ground state Nⱼ and a peak Pe corresponding to the excited states Ne, Nc appear. Then, as shown in FIG. 6B, when the optical pulse corresponding to the energy of the ground state Nⱼ is incident upon the active layer 5, the electron density in the ground state Nⱼ is lowered by the induced emission. A relaxation time such as about 10 ps is required until the reduced electrons are filled up in the ground state Nⱼ. Therefore, a spectrum hole SH appears at the position that corresponds to the energy of the incident light and the gain saturation is caused. As shown in FIG. 6C, when the optical pulse passes through the active layer 5, the gain corresponding to the energy of the ground state Nⱼ is restored by the relaxation of the excited state Ne and the continuous state Nc. A time required to restore the gain is about 10 ps. The electrons are transferred from the excited state Ne and the continuous state Nc to the ground state Nⱼ, the electron density in the excited state Ne and the continuous state Nc is lowered. As shown in FIG. 6D, the reduction in this electron density is supplemented by the carrier injected from the electrodes 9, 10, and then the gain corresponding to the energy of the excited state Ne is restored up to the value in the steady state after about 0.5 ns.

In this manner, a relatively long time is required in the restoration of the electron density in the excited state Ne and the continuous state Nc. However, the number of state of the excited state Ne and the continuous state Nc is larger than that of the ground state Nⱼ. If a sufficient number of electrons is injected previously into these states, the slowness of the restoration of the electron density in the excited state Ne and the continuous state Nc seldom exerts an influence upon the gain of the energy in the ground state Nⱼ.

As described above, in the case of the SOA having the quantum dots 5d, the response time is extremely short since the gain saturation is caused by the generation of the spectrum hole SH. Also, the restoration of the gain is caused by the event that the electrons are supplemented from the excited state Ne or the continuous state Nc to the ground state Nⱼ. Therefore, a recovery time of the gain is also extremely short.

In this case, the quantum dots are set forth in M. Sugawara, “Self-assembled InGaAs/GaAs quantum dots” (Academic Press, 1999).

By applying the semiconductor quantum dots to the active layer 5 of the SOA, the higher speed and the multi-wavelength processing performance of the SOA can be improved rather than the active layer having the single or multiple quantum well structure in the prior art.

In addition, it is described in detail in M. Sugawara et al. Jap. J. Appl. Phys., 40, L488(2000), “Quantum-dot semiconductor optical amplifiers for high bit-rate signal processing over 40 Gb/s” that the SOA having the quantum dot structure can process the multi-wavelength optical signal at a high speed.

The active layer 5 constituting the SOA may have not the semiconductor quantum dot structure shown in FIG. 4 but the bulk semiconductor layer or the semiconductor layer having the single or multiple quantum well structure. The SOA having the quantum dot structure is applied to the signal processing in excess of 40 Gb/s. Also, in the case of the low-speed bit rate below 10 Gb/s, there is no necessity to employ the quantum dot structure as the active layer 5.

The principle applied to employ the above SOA as the optical amplifier will be explained hereunder.

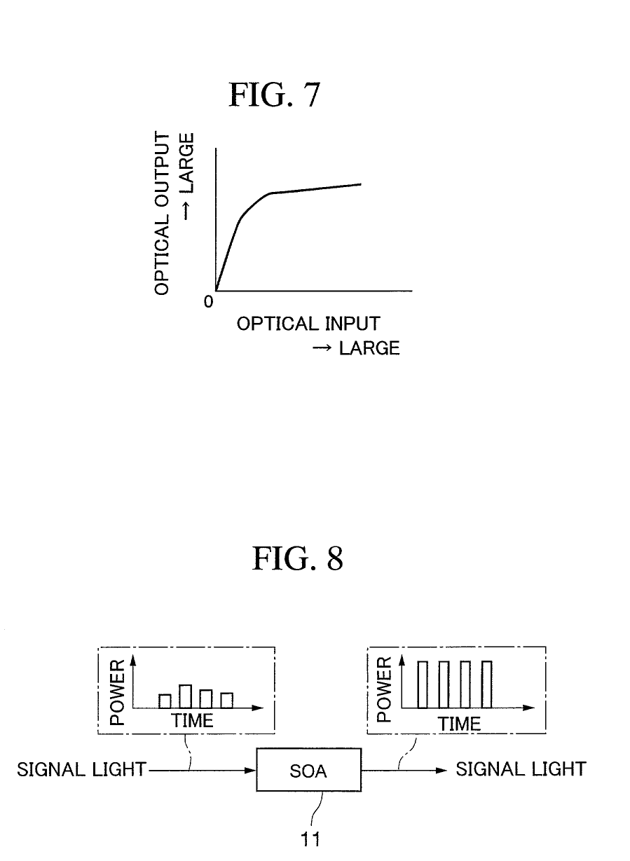

The active layer 5 becomes the population inversion state to generate the gain by applying the forward bias to the pn junction by connecting the DC power supply to the n-side electrode 10 and the p-side electrode 9 of the SOA. Because this structure is formed as the optical waveguide as it is, the light that comes into from one end of the active layer 5 is amplified in the inside and then goes out from the other end. In addition, as shown in FIG. 7, the SOA has such a characteristic that the output light intensity is saturated with respect to the input light intensity. This is called the gain saturation. If the SOA has the quantum dots 5d, the gain saturation is caused by the generation of the spectrum hole.

As a result, as shown in FIG. 8, assume that only the signal optical pulse train is incident upon the input side of the SOA element 11 and that intensities of respective signal optical pulse are varied. The variation of the intensity is caused by various factors in the course of the transmission of the signal optical pulses, e.g., generation of the noise, or disturbance or branch to the system.

Then, the optical signal can be amplified in the SOA element 11 to make the intensity constant and then output. If the SOA element has the quantum dots 5d, the time required to generate the gain saturation is about 1 ps and therefore it is possible to amplify and shape the optical signal of more than 2 Gb/s, which is difficult for the normal SOA. The configuration shown in FIG. 8 is the 2R element and is suitable for the amplification and the shaping of the optical signal whose bit rate is more than 10 Gb/s, particularly more than 40 Gb/s.

Next, the wavelength conversion using the above SOA will be explained hereunder.

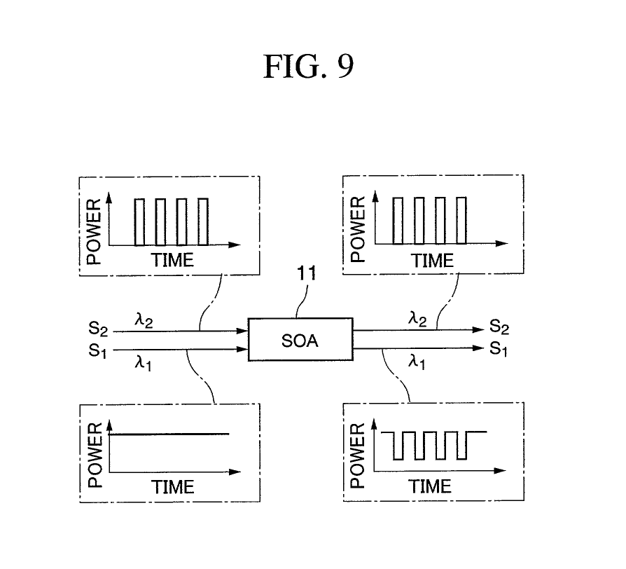

FIG. 9 shows the behavior that an optical signal S₁ as the continuous light having a weak intensity and a first wavelength λ₁ and an optical signal S₂ as a pulse-train having a strong intensity and a second wavelength λ₂ are input simultaneously into the SOA element 11. In this case, the intensities of the optical signals S₁, S₂ and the amplifying characteristic of the SOA element 11 are adjusted previously such that, when the optical signal S₂ incident upon the SOA element 11 becomes a high level, the gain of the SOA element 11 is saturated. Accordingly, since the gain of the SOA element 11 is varied by the ON/OFF of the pulse of the pulse-train optical signal S₂, the intensity of the continuous optical signal S₁ having the first wavelength λ₁ is subjected to the modulation.

That is, the waveform of the optical signal having the first wavelength λ₁ output from the SOA element 11 is just the inverted waveform of the pulse-train optical signal S₂, and thus the wavelength of the optical pulse train can be changed from the second wavelength λ₂ to the first wavelength λ₁. As a result, the SOA element 11 can exhibit a wavelength converting function

If the SOA element 11 is formed as the structure having the quantum dots, the spectrum hole SH is formed when the optical signal S₂ is input into the SOA element 11. The spread of the spectrum hole SH in the energy space comes up to the energy of the optical signal S₁ having the first wavelength λ₁. Therefore, when the high level pulse of the optical signal S₂ is input into the SOA element 11, the gain of the optical signal S₁ is reduced and the output intensity of the optical signal S₁ is lowered. For this reason, the waveform of the first wavelength λ₁ that is obtained by inverting the waveform of the optical signal S₂ by the SOA element 11 is obtained. If the SOA element 11 has the quantum dots 5d, the wavelength conversion of the optical signal in excess of 2 Gb/s, which is difficult for the normal SOA, can be carried out and thus such structure is suitable for the wavelength conversion of the optical signal of more than 10 Gb/s, particularly more than 40 Gb/s.

In this case, if the energy of the optical signal S₁ having the first wavelength λ₁ is contained in the spectrum hole of the optical signal S₂ having the second wavelength λ₂, it is needed that difference of the optical energy between the wavelengths λ₁, λ₂ is smaller than a uniform width (10 to 20 meV at the room temperature) of the gain of the quantum dots.

Next, optical signal processing systems utilizing the above principle will be explained hereunder.

### First Embodiment

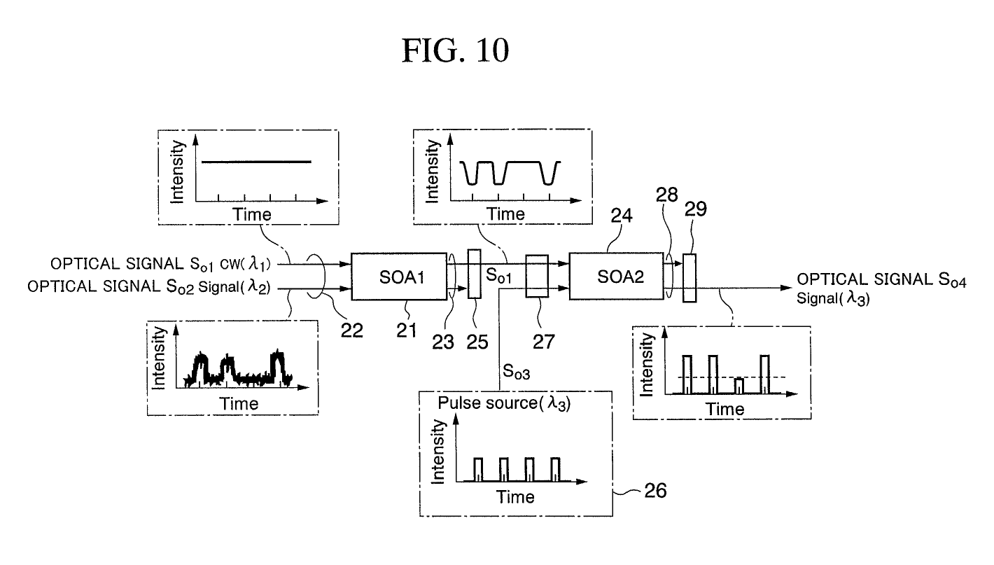

FIG. 10 is a system for processing the optical signal employing two SOA elements.

A first optical fiber 22 for transmitting a first optical signal S₀₁ as the continuous light (CW) having the first wavelength λ₁ and a second optical signal S₀₂ having the second wavelength λ₂ is connected to the input end of a first SOA element 21. Also, an output end of the first SOA element 21 is connected optically to the input end of a second SOA element 24 via a second optical fiber 23. The second optical fiber 23 transmit at least one of the first optical signal S₀₁ and the second optical signal S₀₂.

A first filter 25 and an optical coupler 27 for cutting off the light having the second wavelength λ₂ are fitted in sequence in the middle of the second optical fiber 23 in the light traveling direction.

The optical coupler 27 has a structure for coupling an optical pulse train S₀₃ having a third wavelength λ₃ output from a pulse light source 26 with the light that is transmitted through a first filter 25. The optical pulse train S₀₃ having the third wavelength λ₃ is output from the pulse light source 26 substantially in synchronism with the optical signal that is input into the second SOA element 24 through the second optical fiber 23. Also, the optical pulse train S₀₃ has the bit rate equal to the signal pulse of the second optical signal S₀₂.

A third optical fiber 28 is connected to the output end of the second SOA element 24. A second filter 29 for cutting off the light having the first wavelength λ₁ is fitted to the third optical fiber 28.

In the optical signal processing system having the above configuration, when the first optical signal S₀₁ as the continuous-wave (CW) light having the first wavelength λ₁ and the second optical signal S₀₂ having the second wavelength λ₂ and having the bit pattern are input into the first SOA element 21 through the first optical fiber 22, the first optical signal S₀₁ having the first wavelength λ₁, that is modulated into the inverted state of the waveform of the second optical signal S₀₂ is output from the first SOA element 21. In this case, the second optical signal S₀₂ is the disturbed signal that contains high-frequency ASE noise, variation in the intensity between the bits, disturbance of the waveform, and jitter.

The first optical signal S₀₁ having the first wavelength λ₁, which is output from the first SOA element 21, has the inverted waveform of the optical signal pattern having the second wavelength λ₂ and is amplified. But the ASE noise disappears from the waveform. This is because the frequency of the noise is sufficiently slower than a follow-up speed of the gain saturation.

Also, the variation in the peak value existing in the second optical signal S₀₂ having the second wavelength λ₂ is eliminated in the first optical signal S₀₁ having the first wavelength λ₁, which is output from the first SOA element 21, based on the above principle and thus the peak values are uniformized. In this case, the second optical signal S₀₂ having the second wavelength λ₂, which is output from the first SOA element 21, is cut off by the first filter 25.

In addition, the first optical signal S₀₁ having the first wavelength λ₁, which is output from the first SOA element 21 and on which the signal light pattern is superposed, is coupled with the optical pulse train S₀₃ having the third wavelength λ₃ by the coupler 27 and then is incident upon the input end of the second SOA element 24. In this case, the peak value of the optical pulse train S₀₃ becomes smaller than that of the first optical signal S₀₁.

Then, in the second SOA element 24, the optical pulse train S₀₃ that is synchronism with the weak light intensity portion of the first optical signal S₀₁ is amplified to higher the peak value, and also the peak value of the optical pulse train S₀₃ that is synchronism with the strong light intensity portion of the first optical signal S₀₁ is suppressed low. As a result, an optical signal S₀₄ having the third wavelength λ₃, on which the optical signal pattern of the second optical signal S₀₂ being input into the first SOA element 21 is superposed, is output from the second SOA element 24.

The first optical signal S₀₁ having the first wavelength λ₁, which is output from the second SOA element 24, is cut off by the second filter 29.

As described above, as the result of the employment of the optical pulse train S₀₃ having the third wavelength λ₃ output from the new pulse light source 26, the waveform disturbance and the jitter are eliminated from the optical signal S₀₄ having the third wavelength λ₃, on which the signal pattern of the second optical signal S₀₂ being input into the first SOA element 21 is superposed and which is output from the second SOA element 24.

The optical pulse with the intensity that is below a predetermined intensity may be removed from the optical signal S₀₄ having the third wavelength λ₃, which is output from the second SOA element 24, by the nonlinear filter, etc. as occasion demands.

By employing the above configuration, the optical signal having the deformed waveform can be perfectly regenerated without the conversion into the electric signal. In this case, the setting of λ₂=λ₃ causes no problem at all. If the wavelength conversion is needed, λ₂ and λ₃ may be set to different wavelengths.

The signal processing speed is decided by speeds of the first SOA element 21 and the second SOA element 24. Thus, the high-speed signal optical pulse of more than 40 Gb/s, which cannot be processed in the electric signal, can be regenerated without the pattern effect by employing the SOA having the quantum dots 5d shown in FIG. 4.

According to the same configuration, DEMUX of the OTDM signal can be executed. If the bit rate of the pulse light source 26 is set to the bit rate of the signal component constituting the OTDM signal, only any signal component can be picked out.

The above characteristics are compared with the system in the prior art. As the system in the prior art, the system that employs the Mach-Zehnder Interferometer using the SOA is disclosed in D. Wolfson et al., IEEE Photonic Tech. Lett.12, 332(2000), “40 Gb/s All optical wavelength conversion, regeneration, and demultiplexing in as SSOA- based all active Mach-Zehnder Interferometer”.

As the result of the comparison between the system in the prior art and the present embodiment, according to the present embodiment, there are provided the predominance such that \mathring{1} there is no pattern effect since the quantum dots are employed, \mathring{2} the wavelength conversion into the optical wavelengths other than the employed optical wavelength is not caused, and \mathring{3} complicated optical waveguides such as the Mach-Zehnder Interferometer, etc. are not needed. Also, it is possible to intentionally cause the wavelength conversion freely.

### Second Embodiment

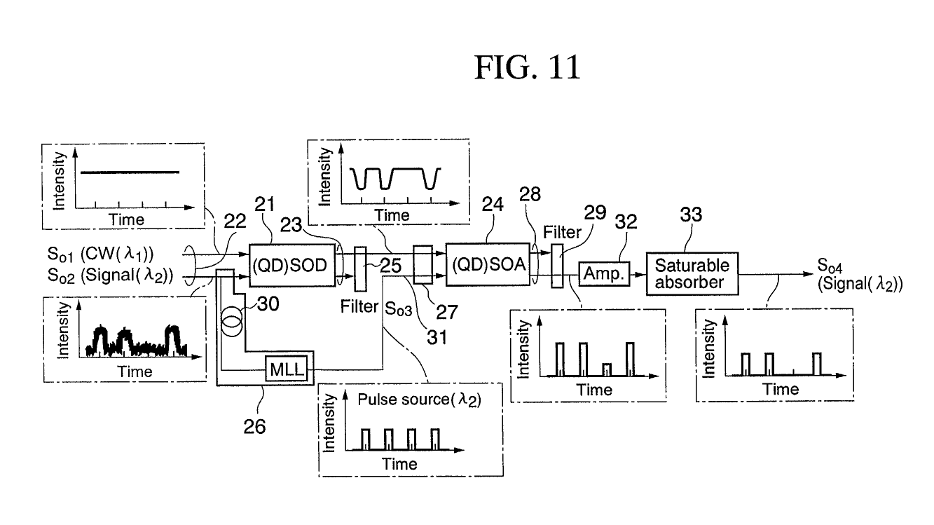

FIG. 11 shows an optical 3R repeater that is constructed by utilizing the structure shown in the first embodiment. In FIG. 11, the same references as those in FIG. 10 denote the same elements. In this case, as the first SOA element 21 and the second SOA element 24, the SOA having the quantum dots (QD) 5d in the active layer 5 shown in FIG. 3 is employed.

FIG. 11 employs a mode-lock laser (MLL) as the pulse light source 26 shown in FIG. 10. The mode-lock laser receives the second optical signal S₀₂ being input into the first SOA element 21 via an optical delay circuit 30 and a third optical fiber 31, and then outputs the signal that is in synchronism with the pulse light of the second optical signal S₀₂ to the second SOA element 24 via the third optical fiber 31. The optical pulse train S₀₃ of the pulse light source 26 has the bit rate that is equal to the signal optical pulse of the second optical signal S₀₂.

The optical delay circuit 30 synchronizes the optical pulse train S₀₃ that is input from the mode-lock laser to the second optical signal S₀₂ having the second wavelength λ₂ that is input into the second SOA element 24.

Accordingly, the wavelength of the optical pulse train S₀₃ of the pulse light source 26 becomes equal to that of the second optical signal S₀₂, and is equivalent to the configuration in which λ₂=λ₃ is set in the system in FIG. 10. As a result, the wavelength of the optical signal S₀₄ that is output from the second SOA element 24 becomes λ₂. Also,

Also, an optical amplifier 32 and a saturable absorber 33 are connected sequentially to the second optical fiber 28, which is connected to the second SOA element 24 on the output side of the second filter 29, in the light traveling direction. Therefore, the perfect pattern of the second optical signal S₀₂ can be reproduced in the optical signal S₀₄ that is output from the optical signal processing system shown in FIG. 11. That is, the intensity of the optical signal S₀₄ that is transmitted through the second filter 29 from the second SOA element 24 is amplified to a predetermined magnitude by the optical amplifier 32, and also the light having the intensity that is below the predetermined value is cut off by the saturable absorber 33. As the saturable absorber 33, for example, the semiconductor amplifier that oscillates when a quantity of light that is in excess of the threshold value is input is employed.

According to the above configuration, the second optical signal S₀₂ having the second wavelength λ₂, whose wavelength is collapsed because of ASE noise, waveform disturbance, jitter, etc., can be reproduced into the perfect pattern by reshaping, amplifying, and retiming, and can be output substantially from the saturable absorber 33 without the wavelength conversion.

### Third Embodiment

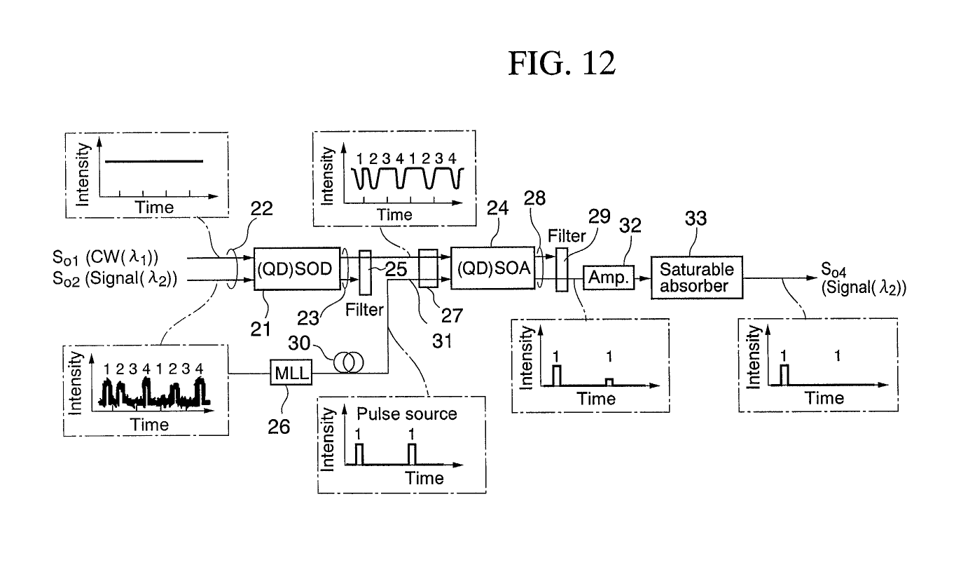

FIG. 12 shows the DEMUX device that is constructed by utilizing the configuration shown in the first embodiment. In FIG. 12, the same references as those in FIG. 10, FIG. 11 denote the same elements. In this case, as the first SOA element 21 and the second SOA element 24, the SOA having the quantum dots (QD) 5d in the active layer 5 shown in FIG. 3 is employed.

The DEMUX device employs the mode-lock laser (MLL) as the pulse light source 26. The optical pulse train S₀₃ output from the mode-lock laser has the bit rate equal to respective signal components constituting the multiple signal optical pulse of the second optical signal S₀₂ that is input into the first SOA element 21.

The mode-lock laser inputs the optical pulse train S₀₃ having the second wavelength λ₂ at 40 Gb/s into the second SOA element 24 via the third optical fiber 31. The optical delay circuit 30 is fitted to the third optical fiber 31 between the optical coupler 27 and the pulse light source 26.

Therefore, the pulse train having the same second wavelength λ₂ as the second optical signal S₀₂ is input from the pulse light source 26 to the second SOA element 24. As a result, the wavelength of the optical signal S₀₄ that is output from the second SOA element 24 and passed through the second filter 29 becomes λ₂.

Meanwhile, the second optical signal S₀₂ having the second wavelength λ₂, that is input into the first SOA element 21, is a quadruple OTDM signal of 160 Gb/s. In the OTDM signal, four time-divided signal trains are discriminated by affixing numbers 1, 2, 3, 4 in the optical waveform in FIG. 12.

Also, the optical amplifier 32 and the saturable absorber 33 are connected in sequence to the optical fiber 28 on the outside of the second filter 25 in the light traveling direction, and thus the perfect pattern can be reproduced as the optical signal. That is, the intensity of the optical signal S₀₄ that is output from the second SOA element 24 is amplified up to the predetermined magnitude by the optical amplifier 32, and also the light having the intensity that is below the predetermined value is cut off by the saturable absorber 33.

In the DEMUX device having the above configuration, when the first optical signal S₀₁ as the continuous light having the first wavelength λ₁ and the second optical signal (OTDM signal) S₀₂ having the second wavelength λ₂ are input into the first SOA element 21 via the first optical fiber 22, the first optical signal S₀₁ whose waveform is the inverted waveform of the second optical signal S₀₂ is output from the first SOA element 21.

The second optical signal S₀₂ is the disturbed signal that contains the high-frequency ASE noise, the variation in the intensity between the bits, the waveform disturbance, and the jitter. In this case, the light having the first wavelength λ₁, which is output from the first SOA element 21, has the inverted waveform of the optical signal pattern of the second optical signal S₀₂ and also is amplified, but the ASE noise disappears from the waveform. This is because the frequency of the noise is sufficiently slower than the follow-up speed of the gain saturation.

Also, the variation in the intensity existing in the second optical signal S₀₂ having the second wavelength λ₂ is not reflected on the first optical signal S₀₁, which is output from the first SOA element 21, based on the above principle, and thus the peak values are uniformized. In this case, the second optical signal S₀₂ output from the first SOA element 21 is cut off by the first filter 25.

In addition, the first optical signal S₀₁ having the first wavelength λ₁, which is output from the first SOA element 21 and on which the signal optical pattern is superposed, as well as the optical pulse train S₀₃ output from the pulse light source 26 is input into the second SOA element 24. The intensity of the optical pulse train S₀₃ becomes smaller than the first optical signal S₀₁ output from the first SOA element 21. In this case, the leading portion (high level portion) of the optical pulse train S₀₃ output from the pulse light source 26 is adjusted by the optical delay circuit 30 so as to synchronize with the number 1 of the first optical signal S₀₁ output from the first SOA element 21.

Then, in the second SOA element 24, the high level portion of the optical pulse train S₀₃ output from the pulse light source 26 is amplified in synchronism with the low level light #1 of the quadruple signal trains of the first optical signal S₀₁. Also, the low level portion of the optical pulse train S₀₃ output from the pulse light source 26 is reduced in intensity in synchronism with the number 1 of the quadruple signal trains having the first wavelength λ₁. Accordingly, the optical pulse train S₀₃ is modulated to provide the optical signal S₀₄.

The first optical signal S₀₁ having the first wavelength λ₁ output from the second SOA element 24 is cut off by the second filter 29. Also, the pulses having the small intensity, which are not contained in the first pulse train of the second optical signal S₀₂, are contained in the optical signal S₀₄ having the second wavelength λ₂ output from the second filter 29. Therefore, such intermediate-level pulses are amplified by the optical amplifier 32 and then are cut off by the saturable absorber 33.

As a result, only the optical signal train of the second optical signal S₀₂, which is input into the first SOA element 21 and has the predetermined number, can be reproduced and picked up. In addition, the reproduced optical signal has the perfect pattern waveform in which disturbances such as the ASE noise, the jitter, etc. do not exist.

### Other Embodiment

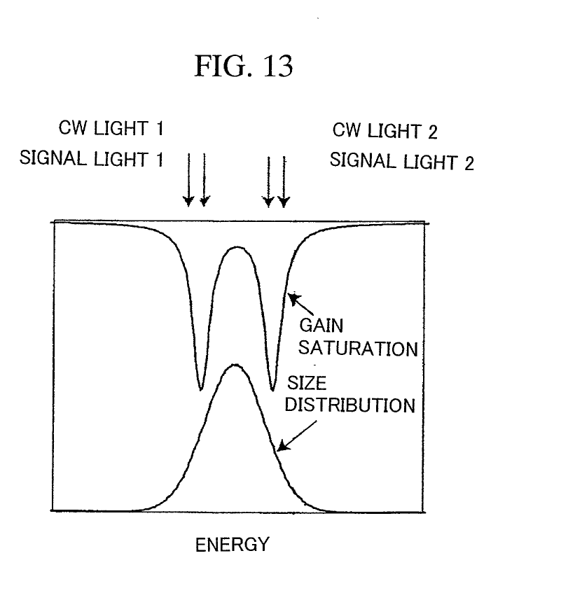

It is conceptually shown in FIG. 13 that the optical signal processing systems employing the present invention as described above can execute the multi-wavelength process. According to FIG. 13, it can be understood that the optical signals isolated to exceed the uniform width of the gain in the gain curve, which is spread by the size distribution of the quantum dots, can be processed independently.

As described, according to the present invention, the first light as the continuous light having the first wavelength and the second light having the waveform of the signal optical pulse and the second wavelength are input into the first optical amplifier, whereby the intensity profile of the first light can be modulated into the waveform, which is the inverted waveform of the signal optical pulse, and can be optically amplified. At the stage subsequent to this, the first light that is output from the first optical amplifier and the controlling optical pulse train that is output from the pulse light source are input into the second optical amplifier, whereby the optical pulse of the controlling optical pulse train, which is synchronized with the low level intensity of the first light, can be optically amplified and also the intensity of the optical pulse, which is synchronized with the high level intensity of the first light, can be lowered. Therefore, the second light of the second wavelength having the optical signal whose waveform is collapsed can be wavelength-converted into the output optical signal having the third wavelength by the first and second optical amplifiers and can be reproduced.

In addition, if the third wavelength and the second wavelength are set equal to each other, the output optical signal having the second wavelength can be output from the second optical amplifier, and the optical signal of the second light can be reshaped and amplified without the wavelength conversion and can be perfectly reproduced.

With the above, the perfect reproduction of the optical signals whose waveform is collapsed by the noise, the variation in the intensity, the jitter, etc. can be achieved.

What is claimed is:

1. An optical signal processing system comprising:
a first optical transmitting device for transmitting a first light having a first wavelength in a continuous light state and a second light having signal optical pulses and a second wavelength;
a first optical amplifier for receiving the first light and the second light from the first optical transmitting device;
a pulse light source for outputting a controlling optical pulse train having a third wavelength;
a second optical transmitting device for transmitting the first light on which a waveform is superposed by the first optical amplifier and the controlling optical pulse train output from the pulse light source; and
a second optical amplifier for receiving the first light and the controlling optical pulse train from the second optical transmitting device and outputting an output optical signal having the third wavelength, on which the signal pulse is superposed.

2. An optical signal processing system according to claim 1, wherein the first optical amplifier and the second optical amplifier are a semiconductor optical amplifier.

3. An optical signal processing system according to claim 2, wherein the semiconductor optical amplifier contains semiconductor quantum dots.

4. An optical signal processing system according to any one of claim 1, wherein the controlling optical pulse train having the third wavelength has a bit rate that is equal to the signal optical pulse transmitted through the first optical transmitting device.

5. An optical signal processing system according to claim 1, wherein the signal optical pulse of the second light is an optical time-division multiple signal, and the controlling optical pulse train having the third wavelength has bit rates that are equal to respective signal components constituting the optical time-division multiple signal.

6. An optical signal processing system according to claim 1, wherein the third wavelength is equal to the second wavelength.

7. An optical signal processing system according to any one of claim 1, wherein the signal optical pulse having the second wavelength and the controlling optical pulse train having the third wavelength, both being transmitted over the first optical transmitting device, have an equal bit rate mutually, and
the output optical signal has a waveform that is restored by converting the signal optical pulse from the second wavelength to the third wavelength.

8. An optical signal processing system according to claim 1, wherein the first optical transmitting device and the second optical transmitting device are formed of an optical fiber.

9. An optical signal processing system according to claim 1, wherein the pulse light source is a mode-lock laser.

10. An optical signal processing system according to claim 9, wherein the mode-lock laser irradiates the second light.

11. An optical signal processing system according to claim 9, wherein an optical delay circuit is connected to the mode-lock laser.

12. An optical signal processing system according to claim 1, wherein the first wavelength is different from the second wavelength.

13. An optical signal processing system according to claim 1, wherein a filter for cutting off the second light is arranged in the second optical transmitting device.

14. An optical signal processing system according to claim 1, wherein a filter for cutting off the first light is arranged on an output side of the second optical amplifier.

15. An optical signal processing system comprising:
a first optical transmitting means for transmitting a first light having a first wavelength in a continuous light state and a second light having signal optical pulses and a second wavelength;
a first optical amplifier for receiving the first light and the second light from the first optical transmitting means;
a pulse light source for outputting a controlling optical pulse train having a third wavelength;
a second optical transmitting means for transmitting the first light on which a waveform is superposed by the first optical amplifier and the controlling optical pulse train output from the pulse light source; and
a second optical amplifier for receiving the first light and the controlling optical pulse train from the second optical transmitting means and outputting an output optical signal having the third wavelength, on which the signal pulse is superposed.
